(19) United States
(12) Patent Application Publication
(10) Pub. No.: US 2016/0149184 A1
(43) Pub. Date: May 26, 2016

(54) SEPARATOR FOR SECONDARY BATTERY AND SECONDARY BATTERY INCLUDING THE SAME

(71) Applicant: SAMSUNG SDI CO., LTD., Yongin-si (KR)

(72) Inventors: Junghyun Nam, Yongin-si (KR); Hoon Seok, Yongin-si (KR); Gain Kim, Yongin-si (KR)

(21) Appl. No.: 14/925,919

(22) Filed: Oct. 28, 2015

(30) Foreign Application Priority Data
Nov. 21, 2014 (KR) 10-2014-0163725

(51) Int. Cl. H01M 2/16; H01M 10/052

(52) U.S. Cl. CPC H01M 2/1646; H01M 2/1686; H01M 2/166; H01M 10/052

(57) ABSTRACT

A separator includes an inorganic coating layer including an inorganic oxide filler and a binder having a core-shell particle structure mixed therein and coated on one surface or both surfaces of the separator. A nonaqueous lithium secondary battery includes: a positive electrode; a negative electrode on the positive electrode; and the separator between the positive electrode and the negative electrode.

### CROSS-REFERENCE TO RELATED APPLICATION

This application claims priority to and the benefit of Korean Patent Application No. 10-2014-0163725 filed on Nov. 21, 2014 in the Korean Intellectual Property Office, the entire content of which is incorporated herein by reference.

### BACKGROUND

1. Field

Aspects of embodiments of the present invention relate to a separator for a secondary battery, which has improved thermal stability, and a secondary battery including the same.

2. Description of the Related Art

With the recent widespread use of secondary batteries in various applications, including a mobile phone, a camcorder, a notebook computer, an energy source for an electric vehicle, and so on, development of secondary batteries that can be repeatedly charged and discharged, for example, lithium secondary batteries, is drawing attention. In general, a lithium secondary battery includes a positive electrode plate, a negative electrode plate and a separator interposed between the positive and negative electrode plates. The separator generally electrically insulates the positive and negative electrode plates from each other. Since micropores are formed in the separator, lithium ions can move through the separator.

A polyolefin-series material may be used as the separator. However, due to a material characteristic and a processing characteristic, including stretching, the polyolefin-series material may undergo extreme heat shrinkage at a high temperature of 100° C. or higher, which is considered as a primary cause of some internal short circuits of the battery.

Due to a high capacity and a high energy density of a conventional lithium secondary battery, internal or external short circuits may occur, which sharply increases a battery temperature. For this reason, improvement of heat resistance of separator materials is being attempted, thereby increasing the safety of the lithium secondary battery.

To overcome the drawbacks of conventional separators, research into a separator including a porous film having an inorganic oxide filler and an organic binder is conducted. However, there still exists a need for separators having high structural, thermal stability.

### SUMMARY

Aspects of embodiments of the present invention provide a separator for a secondary battery, which has improved thermal stability, thereby preventing an electrical short circuit from occurring between positive and negative electrode (or reducing an occurrence of such an electrical short circuit), and a secondary battery including the same.

The above and other objects of embodiments of the present invention will be described in, or be apparent from, the following description of certain embodiments.

According to an embodiment of the present invention a separator for a secondary battery includes an inorganic coating layer including an inorganic oxide filler and a binder having a core-shell particle structure mixed therein and coated on one surface or both surfaces of the separator.

The binder may include a core including an inorganic particle, and a shell including an organic material coated on particle surfaces of the core.

The binder may have one selected from a substantially spherical shape, a plate-like shape and an amorphous shape.

The inorganic oxide filler may include an inorganic oxide selected from the group consisting of SiO₂, Al₂O₃, Al(OH)₃, AlO(OH), TiO₂, BaTiO₃, ZnO₂, Mg(OH)₂, and mixtures thereof, and the inorganic oxide filler may include one selected from the group consisting of aluminum nitride (AlN), silicon carbide (SiC), boron nitride (BoN), and mixtures thereof.

The inorganic oxide filler may have an average particle diameter in a range of about 0.1 μm to about 5 μm.

The core may have an average particle diameter in a range of about 0.01 μm to about 2.0 μm.

The core may include one selected from SiO₂, Al₂O₃, Al(OH)₃, AlO(OH), and mixtures thereof.

The shell may be adhered to the particle surfaces of the core by fusion.

The shell may include a silane-based compound.

The shell may be included in the binder in an amount of 10% by weight based on the total weight of the core.

The shell may have a thickness of 50 nm or less.

The shell may be surface-modified by a coupling agent.

The inorganic oxide filler and the binder may be mixed or coupled to have a point contact structure.

The inorganic coating layer may further include an organic binder filling internal spaces between the inorganic oxide filler and the binder. The shell may further include an inorganic material.

According to another aspect of an embodiment of the present invention, there is provided a nonaqueous lithium secondary battery including the separator for a secondary battery. For example, an embodiment of a nonaqueous lithium secondary battery includes: a positive electrode; a negative electrode on the positive electrode; and the separator between the positive electrode and the negative electrode.

In the separator for a secondary battery and the secondary battery including the same according to aspects of embodiments of the present invention, thermal stability of the separator can be improved by coating an inorganic coating layer including an inorganic oxide filler and a binder having a core-shell particle structure mixed therein on one surface or both surfaces of the separator.

### BRIEF DESCRIPTION OF THE DRAWINGS

The above and other features and advantages of embodiments of the present invention will become more apparent from the following description of certain embodiments thereof with reference to the attached drawings in which:

FIG. 1 is a cross-sectional view of a separator for a secondary battery according to an embodiment of the present invention;

FIG. 2 is a cross-sectional view illustrating a binder included in an inorganic coating layer of the separator for a secondary battery according to an embodiment of the present invention;

FIG. 3 is a cross-sectional view of a separator for a secondary battery according to another embodiment of the present invention; and

FIG. 4 is a graph illustrating a dimension change of the separator for a secondary battery according to an embodiment of the present invention.

### DETAILED DESCRIPTION

Hereinafter, some example embodiments are described in further detail with reference to the accompanying drawings.

Example embodiments will now be described more fully hereinafter with reference to the accompanying drawings; however, they may be embodied in different forms and should not be construed as being limited to the embodiments set forth herein. Rather, these embodiments are provided so that this disclosure will be thorough and complete, and will fully convey embodiments of the invention to those of ordinary skill in the art.

In the drawings, thicknesses of layers and regions may be exaggerated for clarity. Like numbers refer to like elements throughout. As used herein, the term “and/or” includes any and all combinations of one or more of the associated listed items.

The terminology used herein is for the purpose of describing particular embodiments and is not intended to limit the invention. As used herein, singular forms are intended to include the plural forms as well, and vice versa, unless the context clearly indicates otherwise. It will be further understood that the terms “comprises,” and/or “comprising,” when used in the present specification, specify the presence of the stated features, integers, steps, operations, elements, and/or components, but do not preclude the presence or addition of one or more other features, integers, steps, operations, elements, components, and/or groups thereof. Also, in the context of the present application, when a first element is referred to as being “on” or “coupled” or “connected” to a second element, it can be directly on, coupled to, or connected to the second element or be indirectly on, coupled to, or connected to the second element with one or more intervening elements interposed therebetween.

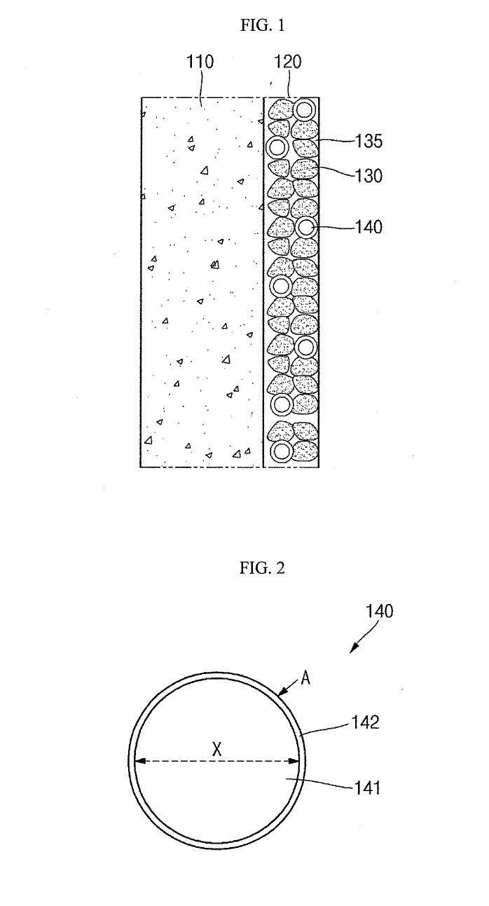

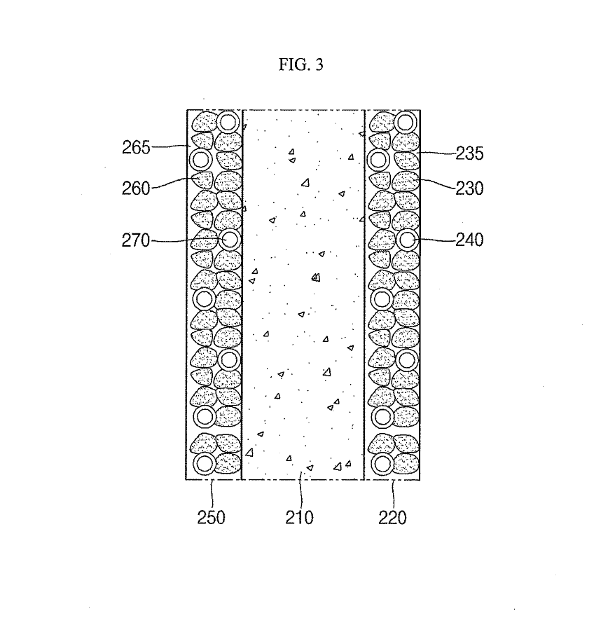

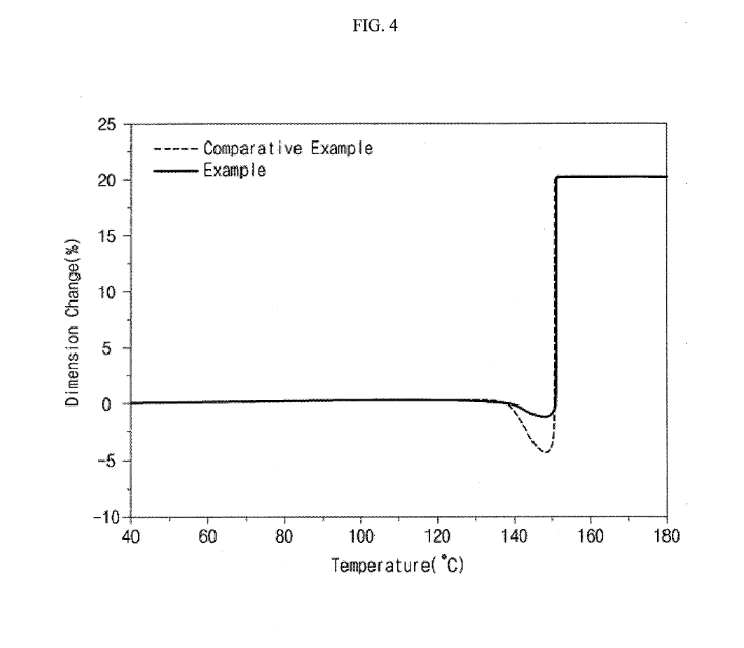

FIG. 1 is a cross-sectional view of a separator for a secondary battery according to an embodiment of the present invention, FIG. 2 is a cross-sectional view illustrating a binder included in an inorganic coating layer of the separator for a secondary battery according to an embodiment of the present invention, FIG. 3 is a cross-sectional view of a separator for a secondary battery according to another embodiment of the present invention, and FIG. 4 is a graph illustrating a dimension change of the separator for a secondary battery according to an embodiment of the present invention.

Referring to FIG. 1, a separator 110 for a secondary battery according to an embodiment of the present invention is configured such that an inorganic coating layer 120 is coated on its one surface.

In an embodiment of a rechargeable battery, the separator 110 is interposed between a positive electrode and a negative electrode and an insulating thin film having high ion transmittance and mechanical strength is used as the separator 110. A polyolefin-based polymer or a polyfluorine-based polymer, which is cheap and has excellent chemical resistance and shut-down performance and high tenacity, may be used as the separator 110. The polyfluorine-based polymer may include, for example, polyvinylidene fluoride or polyvinylidene fluoride hexafluoropropylene copolymer, but the polyfluorine-based polymer is not limited thereto.

The inorganic coating layer 120 is coated on a surface of the separator 110 to improve thermal stability of the separator 110.

To this end, an embodiment of the inorganic coating layer 120 is in a state in which a filler 130 and a first binder 140 having a core-shell particle structure are mixed. The filler 130 and the first binder 140 may be mixed to have a point contact structure (e.g., a point contact structure with one another).

The filler 130 includes an inorganic oxide having a lithium ion transfer capability. In order to form a coating layer having a uniform or substantially uniform thickness and to provide an appropriate or suitable porosity, the inorganic oxide may have an average particle diameter in a range of about 0.1 μm to about 5 μm. When the average particle diameter of the inorganic oxide falls under the range stated above, a uniform or substantially uniform, stable coating layer can be formed on the entire or substantially the entire surface of the inorganic coating layer 120 owing to excellent dispersibility of inorganic oxide and a high fastening force between the first binders 140 and a second binder 135, without or substantially without entailing any or substantially any problem of an electrical short circuit or an increase in the thickness of the separator. The inorganic oxide is not specifically limited in view of its shape so long as its structural stability is suitable or guaranteed. For example, the inorganic oxide may have various suitable shapes, including an amorphous shape, a spherical or substantially spherical shape, and so on, through pulverizing.

As shown in FIGS. 1 and 2, the first binder 140 is coupled or connected to the inorganic oxide forming the filler 130 through a point contact and includes a core 141 and an organic/inorganic composite layer 142. The first binder 140 may chemically bond the core 141 and the organic/inorganic composite layer 142 with each other and may have a spherical or substantially spherical shape.

The core 141 includes inorganic particles. The inorganic particles have a mechanical strength to maintain the core-shell structure and may improve heat resistance of the separator 110. In addition, the inorganic particles may have a relatively small average particle diameter (X) in a range of about 0.01 μm to about 2.0 μm by or as a result of the chemical bond with the organic/inorganic composite layer 142.

The inorganic particles may be selected from SiO₂, Al₂O₃, Al(OH)₃, AlO(OH), TiO₂, BaTiO₃, ZnO₂, Mg(OH)₂, and mixtures thereof, each of which has a lithium ion transfer capability. The inorganic particles may also include aluminum nitride (AlN), silicon carbide (SiC), boron nitride (BoN), or mixtures thereof. The organic/inorganic composite layer 142 has a shape of a shell having a composite layer of an organic material and an inorganic material and is coated on particle surfaces of the core 141, forming the core-shell stricture.

The organic/inorganic composite layer 142 may include a silane-based compound. The silane-based compound offers or provides a binding force for preventing the core 141 from being ruptured (or for reducing an occurrence of such rupture). The silane-based compound is hydrolyzed to be bonded with an organic component or an inorganic component through a dehydration-condensation reaction. For example, vinyltriethoxysilane forms a silane-based compound having a vinyl group on a surface of an inorganic component through a covalent bond between a silanol group formed by hydrolysis of an ethoxy group and a hydroxyl group formed on a surface of an organic component, causing a dehydration-condensation reaction. In addition to the covalent bond, an additional chemical bond (e.g., a non-covalent bond), such as a hydrogen bond or a Van der Waal bond (a Van der Waals force), may also enhance adhesion. Based on the above-described mechanism, the silane-based compound increases an adhesive force between the core 141 and the organic/inorganic composite layer 142.

The silane-based compound may be one or more selected from the group consisting of vinyl silane-based coupling agents such as vinyltrichlorosilane, vinyltris(2-methoxyethoxy)silane, vinyltriethoxysilane, or vinyltrimethoxysilane; (meth)acryl-based silane coupling agents such as 3-methacryloxypropyltrimethoxysilane, or 3-methacryloxypropyltriethoxysilane; epoxy-based silane coupling agents such as 2-(3,4-epoxycyclohexyl)-ethyltrimethoxysilane, 3-glycidyloxypropyltrimethoxysilane, or 3-glycidyloxypropylmethyldiethoxysilane; amino-based silane coupling agents such as N-2-(aminoethyl)-3-aminopropylmethyld imethoxysilane, N-2-(aminoethyl)-3-aminopropyltrimethoxysilane, N-phenyl-3-aminopropyltrimethoxysilane, 3-aminopropylmethyldiethoxysilane, 3-aminopropyltrimethoxysilane, or 3-aminopropyltriethoxysilane; alkoxy-based silane coupling agents such as 3-chloropropyltrimethoxysilane, or 3-chloropropyltriethoxysilane; 3-mercaptopropyltrimethoxysilane, and 3-mercaptopropyltriethoxysilane, but the silane-based compound is not limited thereto.

The organic/inorganic composite layer 142 may be adhered to a surface of the core 141 by fusion. In one embodiment, the organic/inorganic composite layer 142 is coated on the surface of the core 141 including inorganic particles using a chemical coating method. Non-limiting examples of the chemical coating method may include a catalyst polymerization using a catalyst on surfaces of inorganic particles, surface treatment of inorganic particles to be bonded with the organic/inorganic composite layer 142, a chemical deposition such as chemical vapor deposition (CVD), and the like. For example, the organic/inorganic composite layer 142 may be welded or bonded to the surface of the core 141 by the chemical coating method, such as, for example, a sol-gel fusion method.

Alternatively, or additionally, the surface of the core 141 may be modified through various suitable surface modification methods, including treating with a surface modifier before the organic/inorganic composite layer 142 is coated. A representative example of the surface modifier may include, but is not limited to, a coupling agent. Non-limiting examples of the coupling agent may include organic silane compounds, and examples thereof may include dimethyl dimethoxy silane, dimethyl diethoxy silane, methyl trimethoxy silane, vinyl trimethoxysilane, phenyl trimethoxy silane, and tetraethoxy silane. Additional surface modifying methods may include plasma surface treatment, corona discharge treatment, and the like. The surface modifying methods of the core 141 may increase a binding force with the organic/inorganic composite layer 142, thereby greatly contributing to maintenance of the structural integrity of the organic/inorganic composite layer 142 against deformation due to an internally or externally applied force.

The organic/inorganic composite layer 142 may be contained or included in the first binder 140 in an amount of 10% by weight based on the total weight of the core 141 in consideration of the functionality of the inorganic coating layer 120 and adaptability of a high-capacity battery. In embodiments of the present invention, the organic/inorganic composite layer 142 is formed in an amount of 10% by weight based on the total weight of the core 141 to manifest a shut-down function by being melted at a set temperature (e.g., an abnormally high temperature) of a secondary battery, thereby securing thermal stability.

The organic/inorganic composite layer 142 may have a thickness of 50 nm or less (e.g., a thickness of greater than 0 to 50 nm). Here, if the thickness of the organic/inorganic composite layer 142 is 50 nm or less (e.g., greater than 0 to 50 nm), layer integrity can be achieved by sufficient or suitable particle bonds through fusion and a shut-down function can be manifested by being melted at a set temperature (e.g., an abnormally high temperature) of a secondary battery, thereby securing thermal stability. In embodiments of the present invention, the core-shell structure is formed by coating the organic/inorganic composite layer 142 having an amount of 10% by weight and a thickness of 50 nm or less (e.g., great than 0 to 50 nm) on the surface of the core 141, thereby improving heat resistance of the separator 110 and enhancing a ventilation degree.

The second binder 135 is selectively filled in spaces between the filler 130 and the first binder 140 to secure bonds between the filler 130 and the first binder 140 and to achieve heat resistance of the separator 110. For example, the second binder 135 may be included or may not be included in the inorganic coating layer 120 coated on the separator 110 for a secondary battery. Here, the filler 130 may be an inorganic oxide having an irregular shape, for example, one selected from a spherical or substantially spherical shape, an amorphous shape, and a plate-like shape, and the first binder 140 has a spherical or substantially spherical core-shell structure and the filler 130 and the first binder 140 are coupled or connected to each other to have a point contact structure, creating spaces between the filler 130 and the first binder 140. In embodiments of the present invention, the spaces created between the filler 130 and the first binder 140 are filled with the second binder 135, thereby enhancing the thermal stability and adhesion of the separator 110.

In some embodiments, the second binder 135, made of an organic material, is added in an amount that is 2 to 3 times of the amount of the first binder 140. The second binder 135 may include, for example, polyfluorovinylidene, polyvinylalcohol, carboxymethylcellulose (CMC), starch, hydroxypropylcellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluorine rubber, and various other suitable copolymers.

In the aforementioned separator 110 for a secondary battery, the inorganic coating layer 120 may be coated on one surface of the separator 110. In addition, as shown in FIG. 3, the inorganic coating layer may also be coated on two (both) surfaces of the separator 210. In embodiments of the present invention, the fillers 230 and 260 including inorganic oxides and the first binders 240 and 270 having core-shell particle shapes are respectively mixed and the inorganic coating layers 220 and 250, optionally, filled with the second binders 235 and 265 in the spaces between the fillers 230 and 260 and the first binders 240 and 270, respectively, are formed on respective (both) surfaces of the separator 210, thereby improving the thermal stability of the separator 210. For example, the filler 230, the first binder 240, and, optionally, the second binder 235 may be mixed to form the inorganic coating layer 220 which may be on a surface of the separator 210, and the filler 260, the first binder 270, and, optionally, the second binder 265 may be mixed to form the inorganic coating layer 250 which may be on another surface of the separator 210.

The separators 110 and 210 for a secondary battery, including the inorganic coating layers 120, 220 and 250, respectively, according to embodiments of the present invention are interposed between respective positive and negative electrodes to manufacture respective secondary batteries. The secondary battery according to an aspect of embodiments of the present invention includes all suitable elements for performing an electrochemical reaction, and examples thereof may include a primary battery, a secondary battery, a fuel cell, a solar cell, a capacitor such as a super capacitor device, and the like. For example, the secondary battery may be a lithium secondary battery, including a lithium metal secondary battery, a lithium ion secondary battery, a lithium polymer secondary battery, or a lithium ion polymer secondary battery.

In addition, the separators 110 and 210, the coating layer, the positive electrode, the negative electrode, the electrolyte solution and other components of the secondary battery described herein may be in any suitable form available in the related art, may be commercially available or may be easily prepared by any suitable process and/or method available in the related art.

In the separator for a secondary battery and the secondary battery including the same according to aspects of embodiments of the present invention, thermal stability of the separator can be improved by coating an inorganic coating layer having an inorganic oxide filler and a core-shell particle type (or kind) binder mixed therein on one surface or two (both) surfaces of the separator. Accordingly, an electrical short circuit between positive and negative electrodes can be effectively prevented (or an occurrence of such an electrical short circuit can be reduced).

### Example

A separator was prepared by coating on its one surface an inorganic coating layer including 95 parts by weight of an inorganic oxide, 1.5 parts by weight of a first binder, and 3.5 parts by weight of a second binder. Here, separator test pieces were prepared, the test pieces each having a length of 16 mm and a width of 5 mm, the width being substantially perpendicular to the length.

The inorganic oxide was alumina (Al₂O₃), the first binder had an organic/inorganic composite layered core-shell structure including a SiO₂ core and a vinyltrichlorosilane shell, and the second binder was carboxymethylcellulose (CMC).

### Comparative Example

Various ingredients for forming an inorganic coating layer were used in substantially the same amounts as those in the Example. Test pieces of separators each having substantially the same length and width as those of the Example were prepared.

In addition, in the Comparative Example, the inorganic oxide used was alumina (Al₂O₃), which is the same as in the Example, the first binder used was carboxymethylcellulose (CMC), and the second binder was acryl-based silane coupling agent.

### Evaluation Example

For the test pieces prepared in the Example and Comparative Example, tests for a dimension change depending on the temperature of the separator (for example, shrinkage, ventilation, moisture change, etc.) were carried out. In order to measure a dimension change, thermomechanical analysis (TMA) equipment was used. A ventilation degree and a moisture change of the test pieces were measured using a ventilation meter and a moisture sensor device that are generally used, respectively. In addition, the measurement temperature was set to be in a range of room temperature to 200 degrees, and the measurement load was set to 100 mN.

The results of the evaluation tests are listed in Table 1.

TABLE 1

| | Comparative Example | Example |
|---|---|---|
| Dimension Change | 4.3 | 1.2 |
| (Shrinkage) | | |
| Ventilation Degree (sec) | 145 | 124 |
| Moisture Change (ppm) | 650 | 480 |

As shown in Table 1 and FIG. 4, in a case where an inorganic coating layer having an inorganic oxide filler and a core-shell particle type (or kind) first binder mixed therein is coated on one surface of a separator (as in the Example) or two (both) surfaces of a separator, a dimension change was noticeably reduced, and ventilation and moisture change characteristics were reduced, compared to a case where a coating layer having an inorganic oxide filler mixed with first and second binders that do not have a core-shell structure is coated on a separator (as in the Comparative Example).

While the separator for a secondary battery and the secondary battery including the same according to the present invention have been particularly shown and described with reference to exemplary embodiments thereof, it will be understood by those of ordinary skill in the art that various changes in form and details may be made therein without departing from the spirit and scope of the present invention as defined by the following claims, and equivalents thereof. It should therefore be understood that the present embodiments should be considered in all respects as illustrative and not restrictive, reference being made to the appended claims, and equivalents thereof, rather than the foregoing description to indicate the scope of the invention.

What is claimed is:

1. A separator for a secondary battery comprising:
an inorganic coating layer comprising an inorganic oxide filler and a binder having a core-shell particle structure mixed therein and coated on one surface or both surfaces of the separator.

2. The separator of claim 1, wherein the binder comprises:
a core comprising an inorganic particle; and
a shell comprising an organic material and an inorganic material and coated on particle surfaces of the core.

3. The separator of claim 1, wherein the binder has one selected from a substantially spherical shape, a plate-like shape, and an amorphous shape.

4. The separator of claim 1, wherein the inorganic oxide filler comprises an inorganic oxide selected from the group consisting of SiO₂, Al₂O₃, Al(OH)₃, AlO(OH), TiO₂, BaTiO₃, ZnO₂, Mg(OH)₂, and mixtures thereof, and the inorganic oxide filler comprises one selected from the group consisting of aluminum nitride (AlN), silicon carbide (SiC), boron nitride (BoN), and mixtures thereof.

5. The separator of claim 1, wherein the inorganic oxide filler has an average particle diameter in a range of about 0.1 μm to about 5 μm.

6. The separator of claim 2, wherein the core has an average particle diameter in a range of about 0.01 μm to about 2.0 μm.

7. The separator of claim 2, wherein the core comprises one selected from SiO₂, Al₂O₃, Al(OH)₃, AlO(OH), and mixtures thereof.

8. The separator of claim 2, wherein the shell is adhered to the particle surfaces of the core.

9. The separator of claim 2, wherein the shell comprises a silane-based compound.

10. The separator of claim 2, wherein the shell is included in the binder in an amount of 10% by weight based on the total weight of the core.

11. The separator of claim 2, wherein the shell has a thickness of 50 nm or less.

12. The separator of claim 2, wherein the shell is surface-modified by a coupling agent.

13. The separator of claim 1, wherein the inorganic oxide filler and the binder are coupled to each other to have a point contact structure.

14. The separator of claim 1, wherein the inorganic coating layer further comprises an organic binder filling internal spaces between the inorganic oxide filler and the binder.

15. A nonaqueous lithium secondary battery comprising:
a positive electrode;
a negative electrode on the positive electrode; and
the separator of claim 1 between the positive electrode and the negative electrode.
